(19) United States
(12) Patent Application Publication
(10) Pub. No.: US 2014/0178744 A1
(43) Pub. Date: Jun. 26, 2014

(54) BATTERY TERMINAL, BATTERY COVER PLATE ASSEMBLY, BATTERY AND BATTERY PACK

(71) Applicants: BYD COMPANY LIMITED, Shenzhen (CN); SHENZHEN BYD AUTO R&D COMPANY LIMITED, Shenzhen (CN)

(72) Inventors: Jianhua ZHU, Shenzhen (CN); Qing LAI, Shenzhen (CN); Zhiwei TONG, Shenzhen (CN); Luxia JIANG, Shenzhen (CN)

(73) Assignees: BYD COMPANY LIMITED, Shenzhen (CN); SHENZHEN BYD AUTO R&D COMPANY LIMITED, Shenzhen (CN)

(21) Appl. No.: 14/193,613

(22) Filed: Feb. 28, 2014

Related U.S. Application Data
(63) Continuation of application No. PCT/CN2012/080449, filed on Aug. 22, 2012.

(30) Foreign Application Priority Data
Aug. 29, 2011 (CN) 201120318949.8
Dec. 14, 2011 (CN) 201110416275.X

(51) Int. Cl. H01M 2/06; H01M 2/02; H01M 2/30

(52) U.S. Cl. CPC H01M 2/06; H01M 2/305; H01M 2/024
USPC 429/158; 429/122; 429/178; 429/180

(57) ABSTRACT

A battery terminal includes an outer terminal segment, the outer terminal segment being made of a first conductive material; an inner terminal segment being made of a second conductive material different from the first conductive material and having an upper end connected to a lower end of the outer terminal segment forming a connection portion between the upper end of the inner terminal segment and the lower end of the outer terminal segment, and a protection member around the connection portion. With the battery terminal according to an embodiment of the present invention into batteries, adjacent batteries can be connected together more reliably.

### CROSS REFERENCE TO RELATED APPLICATIONS

This application is a continuation application of International Application No. PCT/CN2012/080449, filed on Aug. 22, 2012, which claims priority and benefits of Chinese Patent Application No. 201120318949.8, filed with the State Intellectual Property Office of China on Aug. 29, 2011, and Chinese Patent Application No. 201110416275.X, filed with the State Intellectual Property Office of China on Dec. 14, 2011. The entire contents of the above-referenced applications are incorporated herein by reference.

### FIELD

The present disclosure relates to the field of battery, particularly, to a battery terminal, a battery cover assembly, a battery, and a battery pack.

### BACKGROUND

Power battery packs act as the power source for electric vehicles. Power battery packs can be used in severe environments; therefore, there is a relatively high safety standard for power battery packs. Generally, a power battery pack may include a plurality of batteries connected with each other. These batteries may also be referred to as battery cells. Traditionally these batteries can be connected with each other via a connecting piece, which may also be referred to as a battery connector.

Currently, the battery connector can be made of copper, while the positive terminal of a battery can be made of aluminum, and the negative terminal of the battery can be made of copper. When two batteries are connected together, the copper connectors need to be in good connection with each terminal with minimum contact resistance in between. But when a copper component (e.g. the battery connector) and an aluminum component (e.g. the positive terminal of the battery) are subject to moisture, CO₂ and other impurities in the air, an electrolyte solution may be formed in a connection area between the copper component and the aluminum component. The aluminum component may act as a cathode and the copper component may act as an anode, each reacts with the electrolyte. Electrochemical corrosion may take place, which can increase the contact resistance between the copper component and the aluminum component. In addition, the elasticity modulus and the coefficient of thermal expansion of the copper component can be highly different from those of the aluminum component. Therefore, after several hot/cold thermal cycles caused by, for example, connecting and disconnecting the battery from the rest of the battery pack while the battery pack acts a power source, a gap may be formed between the copper component and the aluminum component, which may further increase the contact resistance between the two components and degrade the connection between them.

Furthermore, as the contact resistance between the copper and the aluminum components increases, the temperature of the contact area may increase as current flows through the resistance. The temperature increase may further speed up the oxidation and corrosion, which in turn further degrades the connection and increases the contact resistance, and a self-feeding reaction cycle may occur. This may result in poor reliability of the connections between the batteries. The temperature increase may also generate smoke and ultimately break the connections, thereby shortening the service life of the battery pack and degrading its performance.

Since the reliability of the connections between the batteries in a power battery pack can influence substantially the reliability and performance of the battery pack, there is a demand for improving the reliability of the connections between these batteries.

### SUMMARY OF THE DISCLOSURE

Embodiments of the present disclosure seek to solve at least one of the problems existing in the prior art to at least some extent, or to provide a consumer with a useful alternative.

Embodiments of the present disclosure provide a battery terminal, which includes an outer terminal segment made of a first conductive material, an inner terminal segment made of a second conductive material different from the first conductive material and having an upper end connected to a lower end of the outer terminal segment so as to form a connection portion between the upper end of the inner terminal segment and the lower end of the outer terminal segment, and a protection member around the connection portion.

According to embodiments of the present disclosure, the outer terminal segment of a battery is made of a first conductive material. When a first battery and a second battery, each has a first terminal and a second terminal, are connected together with a battery connector, a first end of the battery connector may be connected with the outer terminal segment of one of the terminals (e.g. first terminal) of the first battery, and a second end of the battery connector may be connected with the other terminal (e.g. second terminal), which is also made of the first conductive material, of the second battery. Such an arrangement can reduce or even avoid the formation of electrolytes in the connection areas even when there is moisture, CO₂, or other impurities in the air, thereby avoiding electrochemical corrosion and substantially maintaining the contact resistance between the battery connector and battery terminals. In some embodiments, the battery connector, the outer terminal segment of one of the terminals (e.g. the first terminal) of the first battery, and the other terminal (e.g. the second terminal) of the second battery, are made of the first conductive material, so that they all have substantially the same elasticity modulus and the same coefficient of thermal expansion. Thus, after several hot/cold thermal cycles caused by, for example, connecting and then disconnecting a battery from the rest of the battery pack, formation of gap between the first end of the battery connector and the outer terminal segment of one of the terminals (e.g. the first terminal) of the first battery can be avoided. Similarly, formation of gap between the second end of the battery connector and the other terminal (e.g. the second terminal) of the second battery can also be avoided. Therefore, the contact resistance between the battery connector and battery terminals can be substantially maintained.

According to embodiments of the present disclosure, the protection member is around the connection portion between the inner terminal segment and the outer terminal segment of the battery terminal. The protection member may prevent the formation of electrolyte solution in the connection portion under moisture, CO₂ and other impurities, when the inner and outer terminal segments are made of different conductive material. Thus, electrochemical corrosion between the inner terminal segment and the outer terminal segment can be prevented. Such an arrangement can further increase the service life of the battery and improve the reliability of the connection between the batteries.

According to embodiments of the present disclosure, the protection member is in the form of a protection layer formed by injection molding, spraying or electroplating. Protection member formed this way can be easy to manufacture and low in cost.

According to embodiments of the present disclosure, the protection member is made of at least one selected from the group consisting of: perfluoro(alkoxy alkane) resub, polypropylene, polyphenylene sulfide, polytetrafluoroethylene, polyvinylidene fluoride and polyphenyl ether. In one embodiment, the protection member is made of polypropylene, polyphenylene sulfide, or polyphenyl ether.

With the protection member implemented according to the aforementioned embodiments, the cost for manufacturing the protection member may be further reduced, while the protection effect of the protection member may be further improved. Therefore, the connection portion between the inner terminal segment and the outer terminal segment can be protected more effectively to support long term usage.

According to embodiments of the present disclosure, the outer terminal segment and the inner terminal segment are connected via welding or a tenon-mortise structure. This arrangement allows firm connection between the outer terminal segment and the inner terminal segment. The arrangement may also reduce the manufacturing difficulty and cost for the battery terminal.

According to embodiments of the present disclosure, one of the outer terminal segment and the inner terminal segment is made of aluminum, and the other of the outer terminal segment and the inner terminal segment is made of copper.

According to embodiments of the present disclosure, the outer terminal segment includes a connection boss on an upper end thereof. This allows the outer terminal segment to be connected to the battery connector more easily and firmly.

According to embodiments of the present disclosure, the battery terminal has a circular cross section. This allows the battery terminal to be fitted with a cover plate of the battery more easily.

Embodiments of the present disclosure also provide a battery cover plate assembly, which includes a battery terminal according to the aforementioned embodiments of the present disclosure, a cover plate fitted over the battery terminal, and an insulating member disposed between the cover plate and battery terminal.

According to embodiments of a battery cover plate assembly of the present disclosure, the connection portion between the inner terminal segment and the outer terminal segment of the battery terminal is located above upper surfaces of the cover plate and the insulating member. As result, the connection portion between the inner terminal segment and the outer terminal segment can be kept away from an electrolyte solution received in the battery, therefore electrochemical corrosion at the interface between the battery terminal and battery core can be avoided.

According to embodiments of a battery cover plate assembly of the present disclosure, the cover plate, the insulating member and the battery terminal are assembled together via injection molding. As result, the difficulty and cost for manufacturing the battery cover plate assembly can be reduced.

According to embodiments of a battery cover plate assembly of the present disclosure, the inner terminal segment of the battery terminal includes a flange on a lower end thereof. The cover plate may include a first sleeve part and a first flange part formed at a lower end of the first sleeve part. The insulating member includes a second sleeve part fitted over the battery terminal and a second flange part disposed between the flange and the first flange part. And the first sleeve part is fitted over the second sleeve part. Such an arrangement provides a simple and stable structure for the battery cover plate assembly.

According to embodiments of a battery cover plate assembly of the present disclosure, a radial dimension of the first flange part of the cover plate is larger than that of the second flange part of the insulating member. The radial dimension of the first flange part is also larger than that of the flange of the inner terminal segment. Therefore, the battery terminal and the cover plate can be isolated from each other by the insulating member, and a battery which incorporates a battery cover plate assembly according to this embodiment may become more stable.

According to embodiments of a battery cover plate assembly of the present disclosure, the second sleeve part of the insulator is fitted over the inner terminal segment of the battery terminal, and the upper end of the inner terminal segment extends out of an upper end of the second sleeve part by a predetermined length. This arrangement allows the inner terminal segment and the outer terminal segment to be connected with each other more easily. The arrangement also allows the protection member of the battery terminal to be around the connection portion between the inner terminal segment and the outer terminal segment of the battery terminal more easily.

According to embodiments of a battery cover plate assembly of the present disclosure, a circumferential groove is formed in an external wall of the inner terminal segment of the battery terminal, in a location below the connection portion between the inner terminal segment and the outer terminal segment of the battery terminal and above the flange of the inner terminal segment. In this embodiment, a portion of the second sleeve part of the insulating member is fitted within the circumferential groove. This allows the second sleeve part of the insulating member to be fitted with the inner terminal segment of the battery terminal more easily and in a more stable manner.

According to embodiments of a battery cover plate assembly of the present disclosure, the insulating member further includes a third sleeve part fitted over the first sleeve part of the cover plate, wherein an upper end of the third sleeve part is connected with an upper end of the second sleeve part so as to substantially seal the upper ends of gaps formed between the first and second sleeve parts and between the first and third sleeve parts. Such an arrangement allows the insulating member to isolate the battery terminal from the cover plate, thereby making the battery more stable.

Embodiments of the present disclosure also provide a battery, which includes a shell, a battery core accommodated in the shell, and a battery cover plate assembly according to the aforementioned embodiments of the present disclosure disposed on the shell to seal the shell.

With a battery incorporating a battery cover plate assembly according to an embodiment of the present disclosure, increase in the contact resistance between battery connector and battery terminal can be prevented. Therefore, the temperature at the connecting area between the battery connector and the battery terminal can be substantially maintained, which provides more stable connection between batteries and improves the performance and service life of a battery pack which includes these batteries. Such a battery can have stable performances and a long service life, and connections between these batteries can be stable.

Embodiments of the present disclosure also provide a battery pack, which includes: a plurality of batteries, which include a first battery and a second battery adjacent to each other, and a battery connector connecting between the first and second batteries. Each of the first and second batteries comprises a first battery terminal and a second battery terminal having opposite polarities, wherein one of the first and second battery terminals is a battery terminal according to aforementioned embodiments of the present invention with an outer terminal segment made of a first conductive material, and the other of the first and second battery terminals is made of the first conductive material. The battery connector is also made of the first conductive material and has a first end connected with the first battery terminal of the first battery, and a second end connected with the second battery terminal of the second battery. Such a battery pack can have stable structure, good performance, and long service life. In a further embodiment of a battery pack of the present disclosure, the battery connector is connected with the first and second battery terminals via a riveting, a threaded connection or welding. Such an arrangement allows the first battery terminal of the first battery and the second battery terminal of the second battery to be firmly connected with each other via the battery connector, and the difficulty and cost for manufacturing the battery pack can be reduced.

With the battery pack comprising a battery connector and a plurality of batteries according to embodiments of the present disclosure, the temperature in the connection areas between the battery connectors and the terminals of the plurality of the batteries included in the battery pack can be substantially maintained. Therefore, the performance and the service life of the battery pack can be improved.

Additional aspects and advantages of embodiments of present disclosure will be given in the following descriptions, become apparent from the following descriptions, or be learned from the practice of the embodiments of the present disclosure.

### BRIEF DESCRIPTION OF THE DRAWINGS

These and other aspects and advantages of the present disclosure will become apparent and more readily appreciated from the following descriptions taken in conjunction with the drawing, in which:

FIG. 1 is a schematic view of a battery cover plate assembly according to an embodiment of the present disclosure, where the battery cover plate includes a battery terminal according to an embodiment of the present disclosure; and

FIG. 2 is a schematic view of a battery pack according to an embodiment of the present disclosure.

### DETAILED DESCRIPTION

Reference will be made in detail to embodiments of the present disclosure; samples of described embodiments are indicated in the drawings. The embodiments described herein with reference to drawings are explanatory, illustrative, and used to generally understand the present disclosure. The embodiments shall not be construed to limit the present disclosure.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, the feature defined with “first” and “second” may comprise one or more this feature. In the description of the present disclosure, the term “a plurality of” means two or more than two, unless specified otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

Moreover, a structure in which a first feature is “on” a second feature may include an embodiment in which the first feature directly contacts the second feature, and may also include an embodiment in which an additional feature is formed between the first feature and the second feature so that the first feature does not directly contact the second feature. In addition, a structure in which a first feature is “on” a second feature may include an embodiment in which the first feature directly contacts the second feature, and may also include an embodiment in which an additional feature is formed between the first feature and the second feature so that the first feature does not directly contact the second feature, unless specified otherwise. Furthermore, a first feature “on,” “above,” or “on top of” a second feature may include an embodiment in which the first feature is right “on,” “above,” or “on top of” the second feature, and may also include an embodiment in which the first feature is not right “on,” “above,” or “on top of” the second feature, or just means that the first feature is at a height higher than that of the second feature. While a first feature “beneath,” “below,” or “on bottom of” a second feature may include an embodiment in which the first feature is right “beneath,” “below,” or “on bottom of” the second feature, and may also include an embodiment in which the first feature is not right “beneath,” “below,” or “on bottom of” the second feature, or just means that the first feature is at a height lower than that of the second feature.

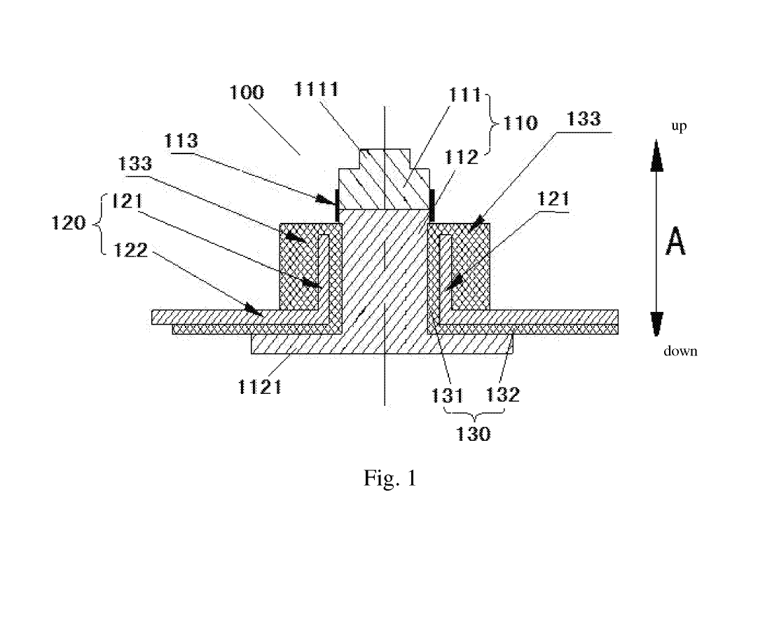

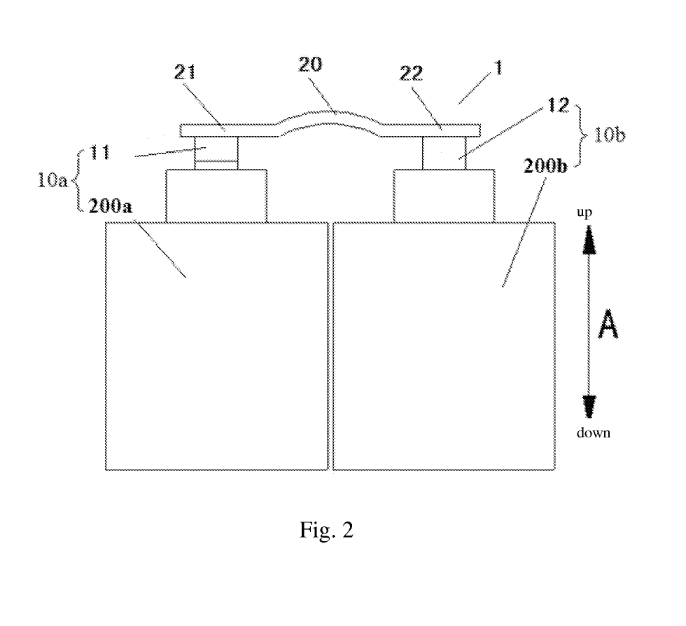

The battery cover plate assembly according to embodiments of the present disclosure, which comprises a battery terminal according to embodiments of the present disclosure, will be described with reference to FIG. 1 below. A battery pack according to embodiments of the present disclosure, which includes batteries incorporating one or more battery cover plate assemblies according to embodiments of the present disclosure, will be described with reference to FIG. 2 below.

FIG. 1 shows a battery cover plate assembly 100 according to embodiments of the present disclosure. As shown in FIG. 1, battery cover plate assembly 100 includes a battery terminal 110, a cover plate 120, and an insulating member 130. The cover plate 120 is fitted over the battery terminal 110. The insulating member 130 is disposed between the cover plate 120 and the battery terminal 110. In FIG. 1, the up and down direction is indicated by an arrow A.

While only one battery terminal 110 is shown in FIG. 1, it will be appreciated that battery cover plate assembly 100 may include two battery terminals 110. In other words, two battery terminals 110 of the battery with the battery cover plate assembly 100 are disposed on the same side of the battery. Alternatively, in some other embodiments the battery includes two battery cover plate assemblies 100, and each battery cover plate assembly 100 includes one battery terminal 110. With two battery terminals 110, one can be used as a positive terminal and the other can be used as a negative terminal.

As shown in FIG. 1, battery terminal 110 may include an outer terminal segment 111, an inner terminal segment 112, and a protection member 113. Outer terminal segment 111 is made of a first conductive material. As shown in FIG. 1, outer terminal segment 111 is a part of battery terminal 110 which is away from a battery core (not shown in FIG. 1), and inner terminal segment 112 is a part of battery terminal 110 which is proximal to the battery core. There are no particular limitations to the lengths of outer terminal segment 111 and inner terminal segment 112, and the lengths may be adjusted as desired. An upper end of inner terminal segment 112 is connected to a lower end of outer terminal segment 111 so as to form a connection portion between inner terminal segment 112 and outer terminal segment 111. As shown in FIG. 1, the connection portion includes a surface at the junction point between outer terminal segment 111 and inner terminal segment 112. Inner terminal segment 112 is made of a second conductive material that is different from the first conductive material. As shown in FIG. 1, protection member 113 is around the connection portion between inner terminal segment 112 and outer terminal segment 111. In some embodiments, protection member 113 may be around a part of inner terminal segment 112 and/or outer terminal segment 111 which is adjacent to the connection portion.

In the embodiment shown in FIG. 1, since inner terminal segment 112 and outer terminal segment 111 are made of different conductive materials, an electrolyte solution may be formed at the connection portion between the inner terminal segment 112 and the outer terminal segment 111 if the connection portion is in direct contact with the moisture, CO₂ and other impurities in the air. With protection member 113 wrapping around the connection portion, the connection portion can be prevented from directly contacting with the moisture, CO₂ and other impurities in the air. Therefore, electrochemical corrosion in the connection portion can be avoided. Such an arrangement can increase the service life of the battery and make the connection between the batteries more stable.

In the embodiments of the present disclosure, protection member 113 is in the form of a protection layer formed via injection molding, spraying or electroplating. Protection member 113 formed this way can be easy to manufacture and low in manufacturing cost.

In the embodiments of the present disclosure, the protection member 113 is made of at least one selected from the group consisting of: perfluoro(alkoxy alkane) resin (PFA), polypropylene (PP), polyphenylene sulfide (PPS), polytetrafluoroethylene (PTFE), polyvinylidene fluoride (PVDF) and polyphenyl ether (PPO). With such an arrangement, the cost for manufacturing protection member 113 may be reduced and the protection effect of the protection member 113 may be improved. In addition, protection member 113 may protect the connection portion between inner terminal segment 112 and outer terminal segment 111 effectively even after a long term use.

In the embodiments of the present disclosure, protection member 113 is made of at least one selected from the group consisting of: PP, PPS and PPO. With such an arrangement, the cost for manufacturing the protection member 113 can be further reduced and the protection effect of the protection member 113 can be further improved. In addition, protection member 113 can protect the connection portion between inner terminal segment 112 and outer terminal segment 111 effectively even after a long term use. Alternatively, protection member 113 may be in the form of a protection layer, such as a nickel layer or a silver layer, formed by electroplating.

In some embodiments of the present disclosure, outer terminal segment 111 and inner terminal segment 112 are connected via a tenon-mortise connection. This arrangement allows easy connection between outer terminal segment 111 and inner terminal segment 112.

In some embodiments of the present disclosure, one of outer terminal segment 111 and inner terminal segment 112 is made of aluminum, and the other of outer terminal segment 111 and inner terminal segment 112 is made of copper. It will be appreciated that the term “aluminum” may refer to pure aluminum or aluminum alloy, and the term “copper” may refer to pure copper and copper alloy.

In some embodiments of the present disclosure, inner terminal segment 112 is connected with outer terminal segment 111 via welding. This arrangement allows inner terminal segment 112 to be firmly connected with outer terminal segment 111, and the difficulty and cost for manufacturing the battery pack can be decreased. In some embodiments, inner terminal segment 112 can be connected with outer terminal segment 111 via explosion welding, friction welding, or brazing.

The dimension ratios (e.g. the length ratio) between outer terminal segment 111 and inner terminal segment 112 can be determined as desired. In some embodiments of the present disclosure, battery terminal 110 is a positive terminal, and the length ratio of inner terminal segment 112 relative to outer terminal segment 111 can be increased. In some embodiments of the present disclosure, battery terminal 110 is a negative terminal, and the length ratio of inner terminal segment 112 relative to outer terminal segment 111 can be decreased. In addition, the dimension ratios between outer terminal segment 111 and inner terminal segment 112 can also be determined according to requirements of the battery for battery terminal 110. In some embodiments of the present disclosure, battery terminal 110 is used in a condition in which the current is relatively high, and the dimension ratios between inner terminal segment 112 and outer terminal segment 111 can be decreased.

As shown in FIG. 1, in an embodiment of the present disclosure, outer terminal segment 111 also includes a connection boss 1111 on an upper end surface thereof. Connection boss 1111 allows outer terminal segment 111 to be connected to battery connector 20 more easily and firmly. In some embodiments of the present disclosure, connection boss 1111 can have a circular cross section and/or have a cylindrical shape. In some embodiments of the present disclosure, connection boss 1111 is formed at the upper end surface of outer terminal segment 111 by welding. Alternatively, connection boss 1111 can be integrally formed with outer terminal segment 111.

As shown in FIG. 1, in an embodiment of the present disclosure, the connection portion between inner terminal segment 112 and outer terminal segment 111 is located above the upper surfaces of cover plate 120 and insulating member 130. Such an arrangement allows the connection portion between inner terminal segment 112 and outer terminal segment 111 to be kept away from electrolyte solution received in the battery. Therefore, electrochemical corrosion at the interface between battery terminal 110 and the battery core (not shown in FIG. 1) can be avoided.

In some embodiments of the present disclosure, cover plate 120, insulating member 130, and battery terminal 110 can be assembled together via injection molding. Such an arrangement can reduce the difficulty and cost for manufacturing battery cover plate assembly 100. Alternatively, cover plate 120, insulating member 130 and battery terminal 110 can also assembled together via a threaded connection, a riveting or an adhering connection.

As shown in FIG. 1, in an embodiment of the present disclosure, inner terminal segment 112 includes a flange 1121 on a lower end thereof. Cover plate 120 includes a first sleeve part 121 and a first flange part 122 disposed at a lower end of first sleeve part 121. Insulating member 130 includes a second sleeve part 131 fitted over battery terminal 110 and a second flange part 132 disposed between flange 1121 of inner terminal segment 112 and first flange part 122 of cover plate 120. First sleeve part 121 of cover plate 120 is fitted over second sleeve part 131 of insulating member 130. With such an arrangement, inner terminal segment 112 can be disposed within second sleeve part 131, which in turn can be disposed within first sleeve part 121 of cover plate 120. This allows battery cover plate assembly 100 to have a simple and stable structure.

In some embodiments of the present disclosure, both first sleeve part 121 of cover plate 120 and second sleeve part 131 of insulating member 130 have a circular cross-section. In some embodiments of the present disclosure, both first flange part 122 of cover plate 120 and second flange part 132 of insulating member 130 have a circular cross-section.

As shown in FIG. 1, in an embodiment of the present disclosure, a radial dimension (e.g. diameter) of first flange part 122 of cover plate 120 is larger than that of the second flange part 132 of insulating member 130, and a radial dimension (e.g. diameter) of second flange part 132 of insulating member 130 is larger than that of flange 1121 of inner terminal segment 112. As a result, an outer edge of second flange part 132 of insulating member 130 can be closer to inner terminal segment 112 than that of first flange part 122 of cover plate 120. Also, an outer edge of flange 1121 of inner terminal segment 112 can be closer to the inner terminal segment 112 than that of the second flange part 132. Such an arrangement allows insulating member 130 to isolate battery terminal 110 and cover plate 120 from each other more completely, therefore the battery can be more stable.

In some embodiments of the present disclosure, second sleeve part 131 of insulating member 130 is fitted over inner terminal segment 112. The upper end of inner terminal segment 112 is extended out of the upper end of second sleeve part 131. Such an arrangement allows inner terminal segment 112 and outer terminal segment 111 to be connected with each other more easily. The arrangement also allows protection member 113 to be around the connection portion between inner terminal segment 112 and outer terminal segment 111 more easily.

As shown in FIG. 1, in an embodiment of the present disclosure, a circumferential groove is formed in an external wall of inner terminal segment 112. A circumferential groove is formed below the connection portion between inner terminal segment 112 and the outer terminal segment 111, and above flange 1121 of inner terminal segment 112. In this embodiment, a portion of second sleeve part 131 is fitted within the circumferential groove. This allows second sleeve part 131 to fit with inner terminal segment 112 more easily and steadily.

In the embodiments of the present disclosure, insulating member 130 further includes a third sleeve part 133 fitted over first sleeve part 121 of cover plate 120, and an upper end of third sleeve part 133 is connected with an upper end of second sleeve part 131 of insulating member 130. Such an arrangement can substantially seal the upper ends of gaps formed between first sleeve part 121 of cover plate 120 and second sleeve part 131 of insulating member 130. Such an arrangement can also substantially seal the upper ends of gaps formed between the first sleeve part 121 of cover plate 120 and third sleeve part 133 of insulating member 130. This allows insulating member 130 to isolate battery terminal 110 and cover plate 120 from each other more completely, therefore the battery can be more stable.

In the embodiments of the present disclosure, cover plate 120 can be made of plastics, aluminum, or stainless steel, therefore cover plate 120 can be lower in cost. In the embodiments of the present disclosure, insulating member 130 can be made of at least one selected from the group consisting of: perfluoro(alkoxy alkane) resin (PFA), polypropylene (PP), polyphenylene sulfide (PPS), polytetrafluoroethylene (PTFE), polyvinylidene fluoride (PVDF) and polyphenyl ether (PPO). With such an arrangement, the cost for manufacturing insulating member 130 can be reduced while the insulating effect of insulating member 130 can be improved. In particular, such an arrangement allows insulating member 130 to isolate battery terminal 110 from the cover plate 120 effectively even after a long term use, therefore the battery can be more stable.

In some embodiments, insulating member 130 can be made of at least one selected from the group consisting of: PP, PPS and PPO. With such an arrangement, the cost for manufacturing insulating member 130 can be further reduced while the insulating effect of insulating member 130 can be further improved. This also allows insulating member 130 to isolate the battery terminal 110 from cover plate 120 effectively even after a long term use, therefore the battery can be more stable.

Referring to FIG. 2, a battery pack 1 according to embodiments of the present disclosure includes a first battery 10a, a second battery 10b, and a battery connector 20 which is made of the first conductive material. A first end 21 of battery connector 20 is connected with a first battery terminal 11 of a first battery of adjacent batteries 10, and a second end 22 of the battery connector 20 is connected with a second battery terminal 12 of a second battery of the adjacent batteries 10. The battery 10a and 10b according to embodiments of the present disclosure include a shell 200 (denoted as shell 200a and 200b), a battery core (not shown in FIG. 2) accommodated in shell 200, and a battery cover plate assembly (not shown in FIG. 2) which is an embodiment of a battery cover plate assembly according to the present disclosure (e.g. battery cover plate assembly 100 shown in FIG. 1). The battery cover plate assembly is mounted on the shell 200 to seal the shell 200. Each of batteries 10a and 10b comprises a first terminal 11 and a second terminal 12. In the following description, by way of example and without limitation, first battery terminal 11 is described as the battery terminal 110 disclosed in FIG. 1. It will be appreciated by those skilled in the art that battery terminals 11 and 12 are interchangeable, therefore any reference to battery terminal 11 in the following description is equally applicable to battery terminal 12, and vice versa. In FIG. 2, the up and down direction is indicated by an arrow A.

As shown in FIG. 2, first end 21 of battery connector 20 is connected with outer terminal segment 111 of battery terminal 11 of battery 10a, and second end 22 of battery connector 20 is connected with battery terminal 12 of battery 10b, such that batteries 10a and 10b are connected in series. It will be appreciated by those skilled in the art that, battery pack 1 according to embodiments of the present disclosure can also include batteries connected in parallel. In other words, battery pack 1 can have all the batteries connected either in series or in parallel, or have some batteries connected in series and some batteries connected in parallel.

According to embodiments of the present disclosure, outer terminal segment 111 of battery terminal 11 of battery 10a and second terminal 12 of battery 10b are made of the first conductive material same as battery connector 20. Therefore, electrolyte solution may not be formed between battery connector 20 and outer terminal segment 111 of battery terminal 11 of battery 10a, nor between battery connector 20 and second battery terminal 12 of battery 10b, under the moisture, CO₂ and other impurities in the air. Thus, electrochemical corrosion in either batteries 10a and 10b can be avoided. This can substantially prevent increase in contact resistances between battery connector 20 and outer terminal segment 111 of battery terminal 11 of battery 10a, and between battery connector 20 and battery terminal 12 of battery 10b. This arrangement also allows battery connector 20 to have substantially the same elasticity modulus and coefficient of thermal expansion as outer terminal segment 111 of battery terminal 11 of battery 10a and second battery terminal 12 of battery 10b. Thus, after several hot/cold thermal cycles caused by connecting with and disconnecting from the batteries from a battery pack that operates as a power source, formation of gaps between battery connector 20 and outer terminal segment 111 of battery terminal 11 of battery 10a, as well as between battery connector 20 and battery terminal 12 of battery 10b, can be prevented. This can further prevent increase in contact resistances between battery connector 20 and outer terminal segment 111 of battery terminal 11 of battery 10a, and between battery connector 20 and battery terminal 12 of battery 10b.

With batteries 10a and 10b implemented according to the aforementioned embodiments, increase of temperature between battery connector 20 and the batteries 10a and 10b can be avoided. This allows more stable connection between batteries 10a and 10b, which in turn gives a stable structure for battery pack 1, and improves the performance and service life of battery pack 1.

According to embodiments of the present disclosure, battery terminal 11, which implements battery terminal 110 of FIG. 1, is used for a positive battery terminal. In such embodiments, inner terminal segment 112 of terminal 11 can be made of aluminum, outer terminal segment 111 of terminal 11 can be made of copper, battery connector 20 can be made of copper, and battery terminal 12 can be made of copper. Alternatively, in some embodiments, battery terminal 11, which implements battery terminal 110 of FIG. 1, is used for a negative battery terminal. In such embodiments, inner terminal segment 112 can be made of copper, outer terminal segment 111 can be made of aluminum, battery connector 20 can be made of aluminum, and battery terminal 12 can be made of aluminum.

According to embodiments of the present disclosure, battery connector 20 can be connected with battery terminal 11 and battery terminal 12 via a riveting, a threaded connection, or welding. This allows battery connector 20 to be firmly connected with battery terminals 11 and 12, and reduces the difficulty and cost for manufacturing battery pack 1. In some embodiments, battery connector 20 can be connected with battery terminals 11 and 12 via welding, such as explosion welding, friction welding, and brazing. This allows effective reduction of the contact resistances between battery connector 20 and either battery terminals 11 and 12. Reference throughout this specification to “an embodiment,” “some embodiments,” “an embodiment”, “another example,” “an example,” “a specific example,” or “some examples,” means that a particular feature, structure, material, or characteristic described in connection with the embodiment or example is included in at least an embodiment or example of the present disclosure. Thus, the appearances of the phrases such as “in some embodiments,” “in an embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory Examples have been shown and described, it would be appreciated by those skilled in the art that the above Examples cannot be construed to limit the present disclosure, and changes, alternatives, and modifications can be made in the Examples without departing from spirit, principles and scope of the present disclosure.

What is claimed is:

1. A battery terminal, comprising:
an outer terminal segment made of a first conductive material;
an inner terminal segment made of a second conductive material different from the first conductive material and having an upper end connected to a lower end of the outer terminal segment so as to form a connection portion between the upper end of the inner terminal segment and the lower end of the outer terminal segment; and
a protection member around the connection portion.

2. The battery terminal of claim 1, wherein the protection member is in the form of a protection layer formed by injection molding, spraying or electroplating.

3. The battery terminal of claim 1, wherein the protection member is made of at least one material selected from the group consisting of: perfluoro (alkoxy alkane) resin, polypropylene, polyphenylene sulfide, polytetrafluoroethylene, polyvinylidene fluoride and polyphenyl ether.

4. The battery terminal of claim 3, wherein the protection member is made of polypropylene, polyphenylene sulfide, or polyphenyl ether.

5. The battery terminal of claim 1, wherein the outer terminal segment and the inner terminal segment are connected via welding or a tenon-mortise connection.

6. The battery terminal of claim 1, wherein one of the outer terminal segment and the inner terminal segment is made of aluminum, and the other of the outer terminal segment and the inner terminal segment is made of copper.

7. The battery terminal of claim 1, wherein the outer terminal segment comprises a connection boss on an upper end thereof.

8. The battery terminal of claim 1, wherein the battery terminal has a circular cross-section.

9. A battery cover plate assembly, comprising:
a battery terminal, which comprises:
an outer terminal segment made of a first conductive material;
an inner terminal segment made of a second conductive material different from the first conductive material and having an upper end connected to a lower end of the outer terminal segment forming a connection portion between the upper end of the inner terminal segment and the lower end of the outer terminal segment; and
a protection member around the connection portion;
a cover plate fitted over the battery terminal; and
an insulating member disposed between the cover plate and the battery terminal.

10. The battery cover plate assembly of claim 9, wherein the connection portion between the inner terminal segment and the outer terminal segment is located above upper surfaces of the cover plate and the insulating member.

11. The battery cover plate assembly of claim 9, wherein the cover plate, the insulating member and the battery terminal are assembled together via injection molding.

12. The battery cover plate assembly of claim 9, wherein the inner terminal segment comprises a flange on a lower end thereof,
wherein the cover plate comprises a first sleeve part and a first flange part formed on a lower end of the first sleeve part,
wherein the insulating member comprises a second sleeve part fitted over the battery terminal and a second flange part disposed between the flange and the first flange part, and the first sleeve part is fitted over the second sleeve part.

13. The battery cover plate assembly of claim 12, wherein a radial dimension of the first flange part is larger than those of the second flange part and the flange, and a radial dimension of the second flange part is larger than that of the flange.

14. The battery cover plate assembly of claim 12, wherein the second sleeve part is fitted over the inner terminal segment, and the upper end of the inner terminal segment is extended out of an upper end of the second sleeve part by a predetermined length.

15. The battery cover plate assembly of claim 14, wherein a circumferential groove is formed in an external wall of the inner terminal segment, and a portion of the second sleeve part is fitted within the circumferential groove.

16. The battery cover plate assembly of claim 12, wherein the insulating member further comprises a third sleeve part fitted over the first sleeve part, an upper end of the third sleeve part is connected with an upper end of the second sleeve part so as to substantially seal upper ends of gaps formed between the first and second sleeve parts and between the first and third sleeve parts.

17. A battery, comprising:
a shell;
a battery core accommodated in the shell; and
a battery cover plate assembly disposed on the shell to substantially seal the shell, wherein the battery cover plate comprises:
a battery terminal, which comprises:
an outer terminal segment made of a first conductive material;
an inner terminal segment made of a second conductive material different from the first conductive material and being connected to the outer terminal segment forming a connection portion between the inner terminal segment and the outer terminal segment; and
a protection member around the connection portion;
a cover plate fitted over the battery terminal; and
an insulating member disposed between the cover plate and the battery terminal.

18. A battery pack, comprising:
a plurality of batteries, each of the plurality of batteries comprising first and second battery terminals having opposite polarities, wherein one of the first and second battery terminals is the battery terminal according to claim 1, and the other of the first and second battery terminals is made of the first conductive material; and
a battery connector made of the first conductive material, and having a first end connected with the first battery terminal of a first battery of adjacent batteries and a second end connected with the second battery terminal of a second battery of the adjacent batteries.

19. The battery pack of claim 18, wherein the battery connector is connected with the first and second battery terminals via a riveting, a threaded connection or welding.
